(19) United States
(12) Patent Application Publication
(10) Pub. No.: US 2008/0014342 A1
(43) Pub. Date: Jan. 17, 2008

(54) COMPOSITE TUBE, METHOD OF PRODUCING FOR A COMPOSITE TUBE, AND USE OF A COMPOSITE TUBE

(75) Inventors: Dietlinde Jakobi, Koln (DE); Hans-Peter Duster, Gummersbach (DE); Carlos Marturet, Pamplona (ES)

Correspondence Address: HENRY M FEIEREISEN, LLC, 350 FIFTH AVENUE, SUITE 4714, NEW YORK, NY, 10118, US

(73) Assignee: Schmidt + Clemens GmbH + Co., KG, Lindlar (DE)

(21) Appl. No.: 11/673,800

(22) Filed: Feb. 12, 2007

Related U.S. Application Data
(63) Continuation of application No. PCT/EP05/08813, filed on Aug. 12, 2005.

(30) Foreign Application Priority Data
Aug. 12, 2004 (DE) 10 2004 039 356.7

(51) Int. Cl. B05D 7/14; F16L 9/133

(52) U.S. Cl. 427/181; 138/143; 420/428; 420/453; 420/51; 420/54

(57) ABSTRACT

To provide a tube which is particularly well matched to the specific demands imposed in special application areas, such as for example hydropyrolysis, the invention proposes a composite tube having a first part-tube and a second part-tube, in which—one part-tube is arranged in the other part-tube,—the first part-tube is a centrifugally cast tube, and—the second part-tube has been produced by pressure treatment from a powder.

### CROSS-REFERENCES TO RELATED APPLICATIONS

This application is a continuation of prior filed copending PCT International application No. PCT/EP2005/008813, filed Aug. 12, 2005, which designated the United States and has been published but not in English as International Publication No. WO 2006/018251 and on which priority is claimed under 35 U.S.C. §120, and which claims the priority of German Patent Application, Serial No. 10 2004 039 356.7, filed Aug. 12, 2004, pursuant to 35 U.S.C. 119(a)-(d), the contents of which are incorporated herein by reference in their entirety as if fully set forth herein.

### BACKGROUND OF THE INVENTION

The invention relates to a composite tube, to a process for producing a composite tube and to uses of a composite tube.

Tube furnaces in which a hydrocarbon/steam mixture is passed through a series of individual or meandering tubes (cracking tube coils) at temperatures of above 750° C. made from heat-resistant chromium-nickel-steel alloy with a high resistance to oxidation or scaling in flue gases and a high resistance to carburization have proven suitable for the high-temperature pyrolysis of hydrocarbons (crude oil derivatives). The tube coils comprise, for example, vertically running, straight tube sections which are connected to one another via U-shaped tube bends; they are usually heated with the aid of side-wall burners and in some cases also with the aid of bottom burners and therefore have what is known as a light side, facing the burners, and what is known as a dark side, which is offset by 90° with respect thereto, i.e. runs in the direction of the rows of tubes. The mean tube metal temperatures (TMT) are in some cases over 1000° C.

The service life of the cracking tubes is dependent to a very significant extent on their carburization resistance and this in turn is dependent on the coking rate. A crucial factor for the coking rate, i.e. the growth of a layer of carbon deposits (pyrolysis coke) on the tube inner wall is, in addition to the type of hydrocarbons used, the cracking gas temperature in the region of the inner wall and what is known as the operating severity, which conceals the influence of the system pressure and the residence time in the tube system on the ethylene yield. The operating severity is set on the basis of the mean outlet temperature of the cracking gases (e.g. 850° C). The higher the gas temperature in the vicinity of the tube inner wall above this temperature, the more extensive the growth of the layer of pyrolysis coke becomes, and the insulating action of this layer allows the tube metal temperature to increase still further. Although the chromium-nickel-steel alloys containing 0.4% of carbon, over 25% of chromium and over 20% of nickel, for example 35% of chromium, 45% of nickel and if appropriate 1% of niobium, that are used as tube material have a high resistance to carburization, and carbon diffuses into the tube wall at defects in the oxide layer, where it leads to considerable carburization, which can amount to carbon contents of from 1% to 3% at wall depths of 0.5 to 3 mm. This is associated with considerable embrittlement of the tube material, with the risk of crack formation in the event of fluctuating thermal loads, in particular when the furnace is being started up and shut down.

To break down the carbon deposits (coking) on the tube inner wall, it is necessary for cracking operation to be interrupted from time to time and for the pyrolysis coke to be burnt with the aid of a steam/air mixture. This requires operation to be interrupted for up to 36 hours, and therefore has a considerable adverse effect on the economics of the process.

British patent 969 796 has disclosed the use of cracking tubes with inner fins. Although inner fins of this type result in an internal surface area which is a good percent, for example 10%, larger, with a corresponding improvement in the heat transfer, they are also associated with the drawback of a considerably increased pressure loss compared to a smooth tube, on account of friction at the enlarged tube inner surface. The higher pressure loss requires a higher system pressure and therefore has an adverse effect on the yield. An additional factor is that known tube materials with high carbon and chromium contents can no longer be profiled by cold-working, for example cold-pressing. They have the drawback that their deformability decreases greatly as the hot strength and the resistance to carburization and oxidation increase. This has led to the high tube metal temperatures of, for example, up to 1050° C., which are desirable with regard to the ethylene yield, requiring the use of centrifugally cast tubes.

In centrifugal casting, the molten alloy is cast into the end of a tubular casting mould which rotates at such a high velocity that the molten alloy forms a layer of liquid alloy on the inner side of the casting mould. After the alloy has solidified, the rotation of the casting mould is stopped and the tube which has been formed in this way can be ejected. The tube is drilled out over its length in order to have the required internal diameter. Any oxide impurities will always be lighter than the alloy and will therefore “float” on the inside of the tube, with the result that they are removed by the drilling.

However, since centrifugally cast tubes can only be produced with cylindrical walls, a special cutting or electrolytically material-removing machining operation is required to produce an internally finned tube.

European patent EP 0 980 729 B1 describes this type of electrolytic machining of a centrifugally cast tube. For this purpose, the tube blank is introduced in to a holding device which is sealed all the way around at its open ends. The sealing only allows an electrolyte to flow in and out and an electrode bar, which has an electrode attached to its end, to pass through; the electrode can be moved by means of the electrode bar along the inside of the tube to be machined, in the axial direction of the tube. On its outer surface, the electrode has a series of peaks and valleys. The material of the inner side of the tube is electrolytically removed by a voltage difference being applied between the electrode and the tube via electrical terminals, which are arranged spaced apart along the tube, and via a current connection block at the end of the electrode bar. In this way, the tube interior is provided with a profile of the geometric shape of the outer surface of the electrode. However, this process has proven complex to carry out.

The production of composite tubes by centrifugal casting, with the part-tubes produced in separate machining steps and being metallurgically joined to one another, is known from U.S. Pat. No. 6,406,800 B1, which describes a tube bend for pipelines for transporting solids. The composite tube used as the starting product for the bent tube is produced by centrifugal casting. First of all, the material which forms the outer tube is poured in the molten state into the casting mould, which rotates at a high speed, so that the molten alloy forms a layer of liquid alloy on the inside of the casting mould. Shortly before the alloy completely solidifies or immediately after complete solidification, the molten alloy which forms the inner tube is likewise poured into the rotating casting mould, so that the molten second alloy forms a layer of liquid alloy on the inside of the virtually solidified first alloy. The two materials are mixed in the transition region between outer tube and inner tube and thereby produce a metallurgical join between the two tubes. The alloys described in U.S. Pat. No. 6,406,800 B1 are not suitable for use in high-temperature pyrolysis. A further drawback is that only alloys which are suitable for centrifugal casting can be used for the inner and outer tubes.

Furthermore, it is known from U.S. Pat. No. 5,069,866 to produce a tube having an outer tube and an inner tube joined to the outer tube by hot isostatic pressing (HIP) from two powders. The austenitic steels or nickel alloys described in that document, however, are likewise not suitable for use in high-temperature pyrolysis.

### SUMMARY OF THE INVENTION

In view of this background, the invention is based on the problem of proposing a tube which is particularly well matched to the specific demands imposed in special application areas, such as for example hydropyrolysis. Furthermore, it is intended to propose a process for producing tubes having an inner tube and an outer tube.

According to one aspect of the present invention, this problem is solved by a composite tube having a first part-tube and a second part-tube, wherein one part-tube is arranged in the other part-tube, the first part-tube is a centrifugally cast tube, and the second part-tube has been produced by pressure treatment from a powder. According to another aspect of the present invention, this problem is also solved by a process for producing a composite tube, wherein a powder is brought into contact with the inner or outer surface of a centrifugally cast tube, and the powder is compacted by pressure treatment to form the second part-tube and joined to the centrifugally cast tube.

The invention is based on the underlying concept of forming a composite tube having a first part-tube and a second part-tube, in which one part-tube is arranged in the other part-tube, the first part-tube is a centrifugally cast tube, and the second part-tube has been produced by pressure treatment from a powder. By combining two part-tubes, it is possible for the tube according to the invention to be specifically matched to the demands imposed in special application areas, such as for example hydropyrolysis.

The second part-tube can be used in particular to improve the corrosion properties, even at temperatures of up to 1200° C., the wear resistance, the carburization and coking behaviour when used in ethylene crackers and the heat transfer of centrifugally cast tubes.

For use in the conveying of highly corrosive media, it is possible to use a centrifugally cast tube made from a corrosion-resistant material having, for example, limited mechanical properties, while the remainder of the wall thickness is made from a less expensive material with good mechanical properties.

On account of its homogeneous microstructure and the possibility of using chromium-nickel steels, a centrifugally cast tube is particularly suitable for the thermal cracking of hydrocarbons. However, by forming a second part-tube, which is produced from a powder, for example by hot isostatic pressing, it is possible to impart further properties to the centrifugally cast tube which are unattainable by such a tube itself. For example, the second part-tube can be made from materials which are not suitable for a centrifugal casting process but can be produced in powder form. Furthermore, the second part-tube can be provided with a geometry, for example a surface profile, during the pressure treatment of the powder. With pure centrifugally cast tubes, geometries of this type can otherwise only be achieved by complex remachining steps, for example a cutting or electrolytically material-removing remachining operation. The composite tube according to the invention may, however, also have a smooth surface. In this case, the advantages of the wider choice of materials which are made possible by the use of a powder come to the fore. Under certain circumstances, it is also possible to dispense with the expensive further treatment of the centrifugally cast tube, for example the drilling operation, for the centrifugally cast tube to be used in the composite.

A composite tube is to understood as meaning a tube which, based on its cross section, has at least two regions (part-tubes), which differ from one another by virtue of the way in which they are produced.

A pressure treatment of the powder is to be understood as meaning any compacting of the powder which, if appropriate in combination with heating of the powder, produces a cohesive solid from the powder or a pre-compacted powder. It is particularly preferable for the second part-tube to be produced by means of hot isostatic pressing (HIP).

In a preferred embodiment, the first part-tube is arranged so as to directly adjoin the second part-tube, as seen in the radial direction of the composite tube, and one of its surfaces is fixedly joined to a surface of the second part-tube. However, it is also possible to provide further part-tubes, in particular further centrifugally cast tubes or further part-tubes produced by pressure treatment from a powder. It is in this way possible to produce various layers of a composite tube which have preferred properties for their particular position in the tube cross section.

In a preferred embodiment, the second part-tube has a profile, in particular one or more internal fins, the profile may also be an external profile. A profile can be used to influence media flowing inside the composite tube according to the invention or media flowing along the outside of the composite tube, for example by swirling them up. The particularly preferred embodiment with internal fins is eminently suitable for use in a process for the thermal cracking of hydrocarbons in the presence of steam.

Depending on the side of the centrifugally cast tube which is to be provided with the particular properties by the second part-tube (outer side/inner side), it is possible to produce the part-tube inside the first part-tube or surrounding the first part-tube.

A preferred flow profile made up of core flow and swirling flow in the composite tube according to the invention with internal fins can be achieved using a composite tube in which the flank angle of the fins, which are preferably continuous from the start of the tube to the end of the tube, i.e. the outer angle between the fin flanks and the radius of the tube, is from 16° to 20°, preferably 17.5° to 18.5°; it is therefore higher than what is known as the venturi angle, i.e. the aperture angle of a venturi nozzle in the direction of flow, which does not usually exceed 15°. A flank angle of this type, in particular in combination with a fin inclination of 20° to 40°, preferably 22.5° to 32.5°, ensures that a more or less continuous turbulent flow which returns to the fin valleys behind the fin flanks, which leads to the formation of undesirable twisters, i.e. closed plaits of turbulence, in the fin valleys, is not produced in the fin valleys. Rather, the turbulence formed in the fin valleys becomes detached from the fin flanks and is taken up by the swirling flow. The swirl energy induced by the fins is therefore substantially retained and is not mostly consumed in the fin valleys. This leads to the tube metal temperature being reduced and made more even and also makes the temperature over the tube cross section more even.

The fins and the fin valleys located between the fins may be designed to be mirror-symmetrical in cross section and adjoin one another or may form a helical line with in each case identical radii of curvature. The flank angle then results between the tangent in the fin valley/fin transition point and the radius of the composite tube. In this case, the fins are relatively shallow; therefore, the fin height, i.e. the radial distance between the fin valleys and the fin peaks, results from the ratio of the fin surface area within the envelope circle and the clear cross section. The ratio should be between 0.06 and 0.01 (preferably between 0.08 and 0.1). Therefore, the fin height increases with increasing diameter, so that the swirling flow is retained in the strength and direction required for the action of the profile.

In other words, the reduction in the clear area, based on a smooth tube with the same diameter as the envelope circle of the profile, is at most 3%, and is preferably from 1.5% to 2.5%.

A greater flow velocity results in the fin valleys, leading to a self-cleaning effect and therefore to fewer deposits of pyrolysis coke.

Tests have shown that—irrespective of the internal diameter of the tubes—a total of 6 to 20, preferably 8 fins are sufficient to achieve the flow profile in accordance with the invention.

In the composite tube with internal fins in accordance with the invention, the ratio of the quotients of the heat transfer coefficients Q_{R}/Q₀ to the quotient of the pressure losses ΔP_{R}/ΔP₀ in the water test, applying and observing the laws of similarity and using the Reynolds numbers determined for a naphtha/steam mixture, is preferably from 1.4 to 1.5, where R denotes a finned tube and 0 denotes a smooth tube.

The superiority of the composite tube according to the invention (profile 3) compared to a smooth tube (profile 0) and a finned tube with axially parallel fins (profile 1), in which the radial distance between the fin valleys and the fin peaks is 4.8 mm, is illustrated by the data in the table below. The finned tubes all had 8 fins and the same envelope circle.

| | PROFILE | | |
|---|---|---|---|
| | 0 | 1 | 3 |
| Fluid temp. at 9950 mm | 843.6 | 848.1 | 843.0 |
| in the centre Tₘ[° C.] | | | |
| Fluid temp. at 9950 mm | 888.9 | 894 | 874.8 |
| at the edge Tᵣ[° C.] | | | |
| Temperature range at | 45.3 | 45.9 | 31.8 |
| 9950 mm | | | |
| ΔT = Tᵣ-Tₘ[° C.] | | | |
| Homogeneity factor with | 1 | 0.9869281 | 1.4245283 |
| respect to the smooth | | | |
| tube Hₜ Hₜ = ΔT₀/ΔTₓ | | | |
| Hydr. diameter dₕ [m] | 0.0380 | 0.0326 | 0.0358 |
| Homogeneity factor with | 1 | 0.8477193 | 1.3420556 |
| regard to hydr. Ø | | | |
| referenced to the | | | |
| smooth tube H_{tØ}:H_{tØ}= ΔT₀ > | | | |
| dₓ/ΔTₓ > d₀ | | | |
| Classification H: | 2 | 2 | 1 |

In the above table, the hydraulic diameter is defined as follows: D_{hydr}=4×(clear cross section)./.internal circumference;

it preferably corresponds to the internal diameter of a comparable smooth tube and then gives a homogeneity factor of 1.425.

In the water test, the composite tube according to the invention gives a heat transfer (Q_{R}) which is higher by a factor of 2.56 compared to the smooth tube, with a pressure loss (ΔP_{R}) which is increased by only a factor of 1.76.

In a preferred embodiment, the first part-tube has an analysis of

| Element | % by weight |
|---|---|
| C | 0.1 to 0.5 |
| Cr | 20 to 50 |
| Ni | 20 to 80 |
| Nb | 0 to 2 |
| Si | 0 to 3 |
| W | 0 to 5 |
| other | 0 to 1 |
| Fe | remainder |

and it is particularly preferable for the first part-tube to consist of one of the DIN EN 10027 Part 1 materials GX40CrNiSi25-20, GX40NiCrSiNb35-25, GX45NiCrSiNbTi35-25, GX35CrNiSiNb24-24, GX45NiCrSi35-25, GX43NiCrWSi35-25-4, GX10NiCrNb32-20, GX50CrNiSi30-30, G-NiCr28W, G-NiCrCoW, GX45NiCrSiNb45-35, GX13NiCrNb45-35, GX13NiCrNb37-25, GX55NiCrWZr33-30-04. These materials have proven particularly suitable for high-temperature use in processes for the thermal cracking of hydrocarbons.

In a preferred embodiment, the second part-tube consists of the same material as the first part-tube. However, to set particular properties, it is also possible for the second part-tube to consist of a ceramic material, an intermetallic material or an ODS material. Intermetallic materials can be made inert in aggressive atmospheres, while ODS materials allow a good creep rupture strength by using finely dispersed oxides.

The process according to the invention for producing a composite tube provides for a powder to be brought into contact with the inner or outer surface of a centrifugally cast tube, and the powder to be compacted by pressure treatment to form the second part-tube and joined to the centrifugally cast tube, in particular metallurgically. The use of a powder to produce the second part-tube makes it possible to produce the part-tube from materials or material combinations which are not suitable for centrifugal casting or can only be produced with considerable outlay (e.g. inert atmosphere). Moreover, it is possible to produce tubes which cannot be centrifugally cast on account of their geometry, such as for example an inner tube with a wall thickness of only a few mm. This in particular gives rise to the possibility of adapting the outer or inner surface of a centrifugally cast tube with specific materials to application areas in which the centrifugally cast materials require special protection, for example protection against corrosion or coking.

The powder can be sprayed onto the surface of the centrifugally cast tube which the second part-tube is to adjoin. This is particularly advantageously implemented if the centrifugally cast tube is at an elevated temperature. For this purpose, the centrifugally cast tube can either be sprayed with the powder immediately after it has been cast or can be specially reheated for the application of the powder.

It is particularly preferable for the powder to be heated during the production of the composite tube. This can particularly preferably take place at the same time as the pressure treatment, for example by means of the hot isostatic pressing that is particularly preferably employed. However, it is also possible for the heating of the powder to precede the pressure treatment. If the pressure treatment and the heating of the powder are carried out simultaneously, the result is a second part-tube with a high density, a low porosity and good metallurgical bonding.

The heating of the powder can be effected by heat transfer from the outside, for example by heating the centrifugally cast tube or by means of a gas stream flowing over the powder or by means of a heating element which is in contact with the powder. However, it is also possible for the powder to be heated inductively.

The powder can be pre-compacted prior to the pressure treatment. This is particularly preferably done by shaking. To improve the handling of the powder, it can be pre-compacted outside the centrifugally cast tube to form a shaped body, for example to form a tube or a cylinder. The pre-compacting can be carried out to a sufficient extent for the shaped body to be suitable for handling, i.e. for example to be self-supporting. The pre-compacted powder in the form of a shaped body is then easy to introduce into the centrifugally cast tube.

The handling properties of the powder can in addition or as an alternative be improved if the powder is bound using a binder, for example to form a shaped body. The binder preferably leaves the powder during the pressure treatment, in particular during a pressure treatment with heating.

It is particularly preferable to produce a composite tube having a second part-tube arranged in the first part-tube by a process in which a core is inserted into a centrifugally cast tube, a clear space which remains between the inner surface of the centrifugally cast tube and the core is filled with a powder, the centrifugally cast tube together with the core and the powder is introduced into a pressure chamber, the pressure chamber is placed under pressure with simultaneous heating of the powder, and after the pressure treatment has concluded, the core is removed from the composite tube produced in this way. The introduction of the powder into a clear space which remains between the inner surface of the centrifugally cast tube and the core has proven advantageous for handling, in particular in the case of a vertically upright centrifugally cast tube. Depending on the spatial conditions, it is possible for the introduction of the core and/or the filling with the powder to take place while a centrifugally cast tube is already inside a pressure chamber.

It is preferable for a core with a profile that is the inverse of a fin profile to be produced on the inner side of the composite tube to be inserted into the centrifugally cast tube. The composite tube therefore receives a second part-tube with an internal profile which can particularly preferably be used in a process for the thermal cracking of hydrocarbons in the presence of steam.

The core can be removed from the composite tube at least in part by means of etching or by mechanical processes. This makes it easy to release the core from the composite tube produced even if the core has in part been metallurgically joined to the second part-tube.

In addition or as an alternative, it is possible for the powder to be provided, on the side facing the core or the mould, with a spacer material, for example a special binder, which prevents metallurgical joining to the core or the mould during the pressure treatment of the powder, in particular during the heating. This is preferably done by evaporating the spacer material at the transition from the powder to the core or to the mould.

To produce a composite tube with the second part-tube provided on the outer side of the centrifugally cast tube, according to a preferred embodiment the centrifugally cast tube is inserted into a mould, a clear space which remains between the outer surface of the centrifugally cast tube and the mould is filled with a powder, the centrifugally cast tube is introduced into a pressure chamber, the pressure chamber is placed under pressure with simultaneous heating of the powder, and after the pressure treatment has concluded, the composite tube produced in this way using a first part-tube and a second part-tube is removed from the mould.

The powder in the clear space between the core and the centrifugally cast tube or the mould and the centrifugally cast tube can be compacted by shaking.

To improve the handling of a centrifugally cast tube with powder that has been introduced into a clear space between the mould and the centrifugally cast tube or the core and the centrifugally cast tube, the clear space is preferably closed off at one end. This in particular allows handling of a vertically upright tube without the powder dropping out of the clear space.

The pressure treatment is carried out in particular at pressures of at least 450 bar, in particular 1000 bar or more. During the heating, the powder is particularly preferably heated to a temperature of at least 450° C., in particular of 1000° C. or more.

The compacting of the powder during the pressure treatment can be carried out under an inert atmosphere. This in particular prevents oxidation of the powder during the production of the second part-tube. It is particularly preferable for the pressure chamber to be filled with an inert gas.

Particularly efficient production of composite tubes according to the invention can be achieved if a plurality of composite tubes are produced together in one pressure chamber.

In the case of a composite tube that is to be produced with helically running internally finned tubes, the helical shape can be generated by producing a composite tube with straight fins and then twisting the ends of the composite tube with respect to one another following production.

The economics of the thermal cracking of hydrocarbons in tube furnaces with externally heated tubes can be improved by the use of a composite tube, since preferred properties can be set for the particular position of the part-tube by means of the different production forms and materials used for the part-tubes of the composite tube. It is particularly preferable to use a composite tube according to the invention in which the first part-tube is a centrifugally cast tube and the second part-tube has been produced by pressure treatment from a powder.

The composite tube according to the invention can in particular be designed and used in such a manner that a swirling flow is generated in the immediate vicinity of the fins and is converted into a core zone with a predominantly axial flow at increasing radial distance from the fins. The transition between the outer zone with the swirling flow and the core zone with the predominantly axial flow is made gradually, for example exponentially.

In the use according to the invention, the swirling flow takes up the detaching turbulence at the fin flanks, so that the turbulence is not locally recycled into the fin valleys in the form of a continuous circular flow. This is associated with an increase in the mean residence time of 10% to 20%, for example 15%. This is ensured in particular if the swirling flow in the region of the fins or the fins themselves run at an angle of from 20° to 40°, for example up to 32°, preferably 22.5° to 32.5°, with respect to the tube axis.

In the use according to the invention, the supply of heat in the tube wall and in the tube interior, which inevitably differs over the tube circumference between the light side and the dark side, is compensated for and the heat is quickly dissipated inwards to the core zone. This is associated with a reduction in the risk of local overheating of the process gas at the tube wall, with the resultant formation of pyrolysis coke. Moreover, the thermal stressing of the tube material is reduced on account of the temperature compensation between light side and dark side, which lengthens the service life. Finally, in the use according to the invention, the temperature over the tube cross section is also made more even, resulting in a better ethylene yield or operating severity. The reason for this is the reversibility of the cracking reaction, which without the radial temperature compensation according to the invention in the tube interior leads to cracking at the hot tube wall and recombination in the centre of the tube.

Furthermore, a laminar flow layer, which is characteristic of turbulent flows, with a greatly reduced heat transfer is formed in the case of a smooth tube and to a greater extent in the case of fin profiles with an internal circumference which is increased by more than 10%. This laminar flow leads to the increased formation of pyrolysis coke, likewise with a poor thermal conductivity. The two layers together require greater introduction of heat or a higher burner capacity. This increases the tube metal temperature (TMT) and correspondingly shortens the service life.

The swirling flow very considerably reduces the laminar layer; moreover, it is associated with a velocity vector which is directed towards the tube centre and reduces the residence time of cracking radicals or cracking products at the hot tube wall and their chemical and catalytic conversion into pyrolysis coke. In addition, the temperature differences between fin valleys and fins, which are not inconsiderable in the case of internally profiled tubes with high fins, are compensated for by the swirling flow according to the invention. This increases the time interval between the need to carry out two coke removal operations. A minimal residence time of the cracking products which have a tendency to coke is improved in the case of cracking tubes provided with internal fins. This is particularly important because without the swirling flow according to the invention a not inconsiderable temperature difference results between the fin peaks and the base of the fin valleys.

In the use according to the invention, it is preferable for the peripheral velocity of the gas flow in the fin valleys to be greater than at the fin peaks.

### BRIEF DESCRIPTION OF THE DRAWING

The present invention will be more readily apparent upon reading the following description of currently preferred exemplified embodiments of the invention with reference to the accompanying drawing, in which:

FIG. 1 is a graphical illustration showing a comparison of swirling or peripheral velocities in a finned tube according to the present invention;

FIG. 2 is a graphical illustration showing the distribution of the circumferential velocity over the tube radius for the profile of a composite tube according to the present invention;

FIG. 3 is a cross sectional view of three test tubes including their data;

FIG. 4 is a graphical illustration showing a comparison of tube metal temperatures;

FIG. 5 is a graphical illustration showing a temperature distribution between light side and dark side for the three tubes of FIG. 3; and

FIG. 6 is an exemplary sectional view of a composite tube according to the present invention.

### DETAILED DESCRIPTION OF PREFERRED EMBODIMENTS

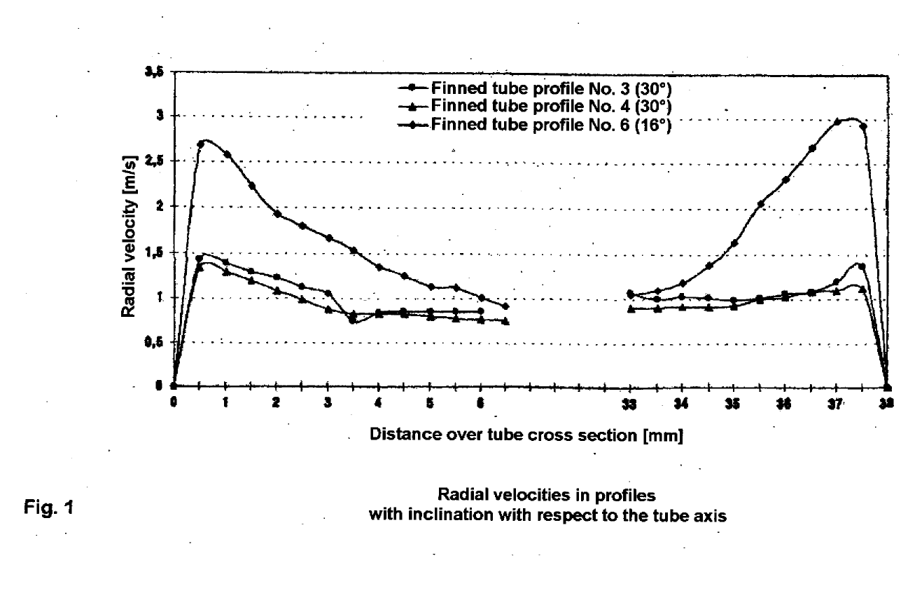

The diagram presented in FIG. 1 includes a comparison of the swirling or peripheral velocities in a finned tube according to the invention (profile 3) with 8 fins and a fin pitch of 30° and two comparison tubes (profiles 4 and 6), each with a fin pitch of 16° and 3 or 8 fins, respectively, over the tube cross section. The curves clearly demonstrate the significantly higher circumferential velocity in the edge zone of the composite tube according to the invention of at most approximately 2.75 or 3 m/s compared to the maximum velocity of only approximately 1.5 m/s in the edge zones of the two comparison tubes.

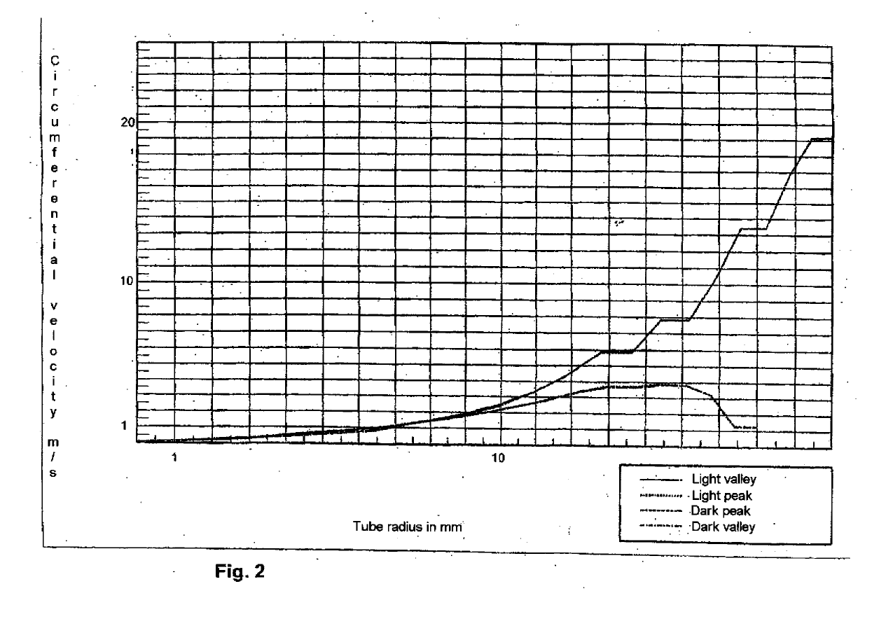

The diagram presented in FIG. 2 shows the distribution of the circumferential velocity over the tube radius for the profile 3 of a composite tube according to the invention. The two—coinciding—upper curves were each measured on a radius which ran through a fin valley on the light side and on the dark side, respectively, while the two lower curves were each measured along the radii which ran through the fin peaks on the light side and dark side, respectively.

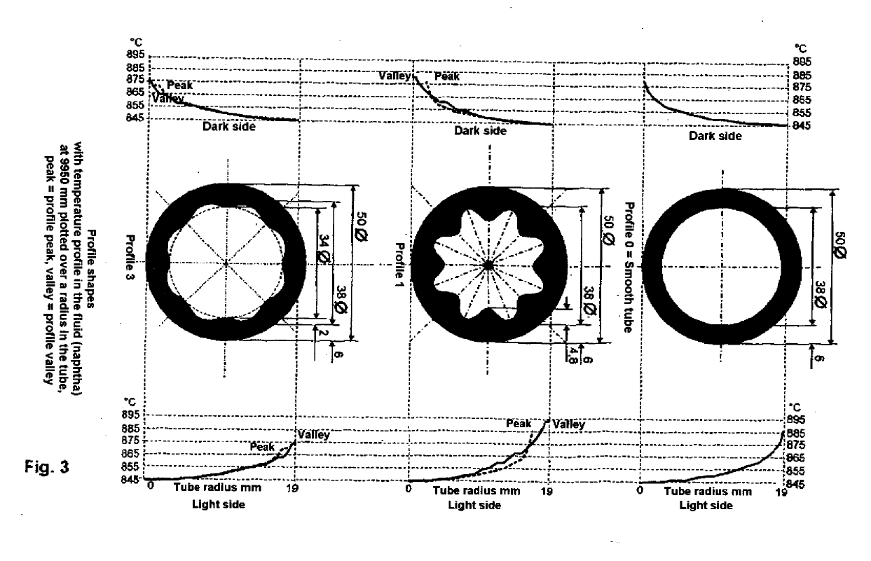

FIG. 3 illustrates three test tubes, including their data, in cross section, including the profile 3 according to the invention The diagrams each indicate the temperature profile across the tube radius on the dark side and the light side. A comparison of the diagrams reveals the lower temperature difference between tube wall and tube centre and the lower tube metal temperature in the case of the profile 3 according to the invention.

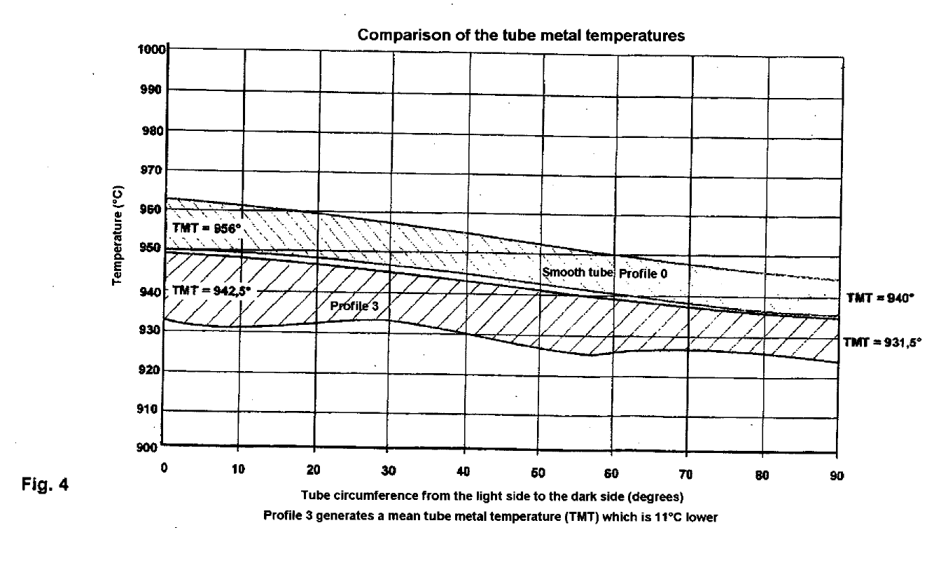

The swirling flow produced with the use of the composite tube according to the invention ensures that the fluctuation in the inner-wall temperature over the circumference of the tube, i.e. between the light side and the dark side, is less than 12° C., even though the tube coils, which are customarily arranged in parallel rows, of a tube furnace are heated or acted on by combustion gases with the aid of side wall burners only on opposite sides and the tubes therefore each have a light side, facing the burners, and a dark side, which is offset through 90° with respect thereto. The mean tube metal temperature, i.e. the difference in the tube metal temperature on the light and the dark side, leads to internal stresses and therefore determines the service life of the tubes. Therefore, the reduction in the mean tube metal temperature of a composite tube according to the invention with eight fins with a pitch of 30°, a tube internal diameter of 38.8 mm and tube external diameter of 50.8 mm, i.e. a difference in height between fin valleys and fin peaks of 2 mm, of 11° compared to a smooth tube of the same diameter, based on a mean service life of 5 years, which can be seen from the diagram presented in FIG. 4, results, at an operating temperature of 1050° C., in a calculated increase in service life to approximately 8 years.

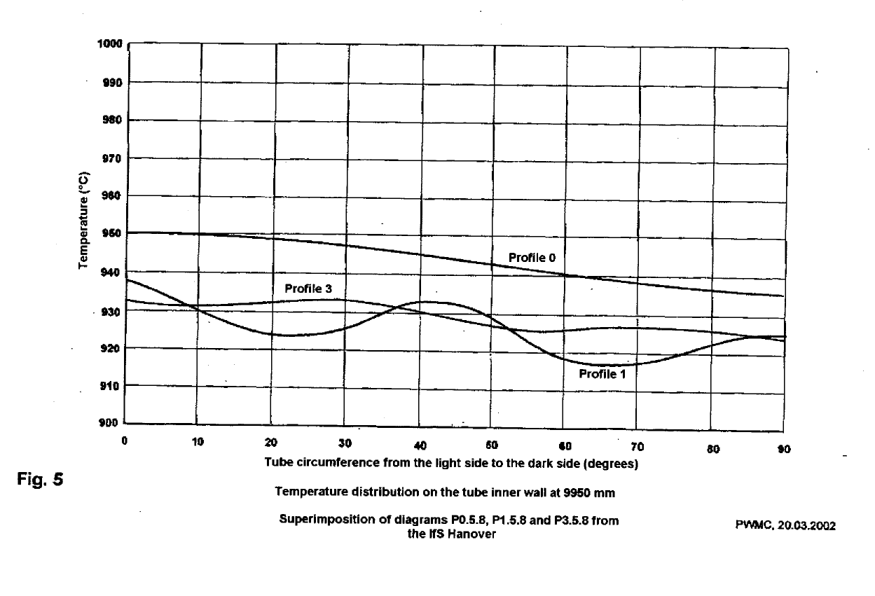

The temperature distribution between the light side and the dark side for the three profiles shown in FIG. 3 is to be found in the diagram shown in FIG. 5. The lower temperature level of the temperature curve for the profile 3 compared to the smooth tube (profile 0) and the considerably narrower fluctuation range for the profile 3 curve compared to the profile 1 curve are noticeable.

A particularly expedient temperature distribution is established if the isotherms run in circles in the core zone and follow the inner profile of the composite tube only in the swirl zone.

A more uniform distribution of the temperature over the cross section results in particular if the swirling flow increases by 1.8 to 20 m/s per metre of tube length and if it covers 7% to 8% of the clear cross section, calculated from the entry of the gas mixture to the profiled tube.

With the use of the composite tube according to the invention, with a view to achieving a high ethylene yield with a relatively short tube length, the temperature homogeneity factor over the cross section and the temperature homogeneity factor referenced on the hydraulic diameter should be over 1 in relation to the homogeneity factors of a smooth tube. In this context, the homogeneity factors are defined as follows:
H_{tØ}:H_{tØ}=ΔT₀>dₓ/ΔTₓ/d₀

The composite tube according to the invention can be used particularly successfully in all high-temperature processes, such as those in which the tube, in particular on the outer side, is exposed to high temperatures of, for example, 800 to 1000° C. In particular, the composite tube according to the invention can be used in the production of coloured pigments, in rotary tubular kilns, for example for the combustion of substances from the chemical industry or pharmaceutical industry, or in refuse incineration plants.

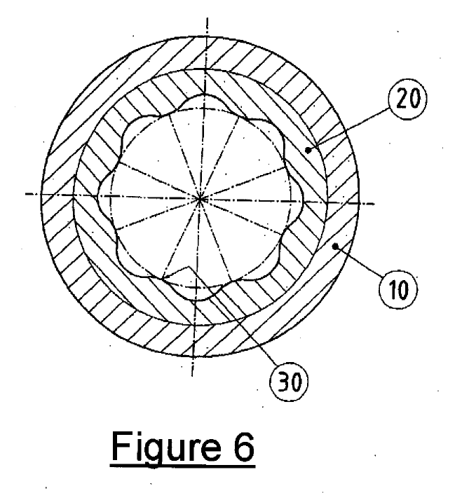

FIG. 6 illustrates an exemplary embodiment of the composite tube according to the invention. It has a first part-tube 10 and a second part-tube 20 with fins 30 which has been produced by pressure treatment from a powder.

1.-44. (canceled)

45. A composite tube, comprising:
a first tube member implemented as a centrifugally cast tube; and
a second tube member produced by pressure treatment from a powder, wherein the first and second tube members are arranged within one another.

46. The composite tube of claim 45, wherein the first tube member is metallurgically joined to the second tube member.

47. The composite tube of claim 45, wherein the second tube member has a profile.

48. The composite tube of claim 45, wherein the second tube member is arranged in the first tube member.

49. The composite tube of claim 47, wherein the second tube member has at least one internal fin as profile.

50. The composite tube of claim 49, wherein the internal fin has a helical configuration.

51. The composite tube of claim 49, wherein the internal fin defines a flank angle from 16° to 20°.

52. The composite tube of claim 49, wherein the internal fin defines a pitch angle from 20° to 40°.

53. The composite tube of claim 49, wherein the second tube member has a plurality of said internal fin, with fin valleys located between the internal fins designed to be mirror-symmetrical in cross section.

54. The composite tube of 53, wherein fin peaks and fin valleys of several of the internal fins adjoin one another.

55. The composite tube of claim 53, wherein the internal fins and the fin valleys of several internal fins have a same radius of curvature.

56. The composite tube of claim 49, wherein the second tube member has a total of six to twenty internal fins.

57. The composite tube of claim 49, wherein the internal fin defines a fin surface area, with a ratio of the fin surface area within a profile envelope circle to a clear cross section of the profile is in a range from less than 0.06 to 0.1.

58. The composite tube of claim 49, wherein a ratio of quotients of heat transfer coefficients Q_{R}/Q₀ to a quotient of pressure losses ΔP_{R}/ΔP₀ in a water test is from 1.4 to 1.5, wherein R denotes a composite tube with fins and 0 denotes a smooth tube.

59. The composite tube of claim 49, wherein the second tubular member is defined by a hydraulic diameter which corresponds to an internal tube diameter of a comparable smooth tube.

60. The composite tube of claim 45, wherein the first tube member is made of a material with the analysis

| Element | % by weight |
|---|---|
| C | 0.1 to 0.5 |
| Cr | 20 to 50 |
| Ni | 20 to 80 |
| Nb | 0 to 2 |
| Si | 0 to 3 |
| W | 0 to 5 |
| Others | 0 to 1 |
| Fe | Remainder |

61. The composite tube of claim 45, wherein the first tube member comprises one of the DIN EN 10027 Part 1 materials selected from the group consisting of GX40CrNiSi25-20, GX40NiCrSiNb35-25, GX45NiCrSiNbTi35-25, GX35CrNiSiNb24-24, GX45NiCrSi35-25, GX43NiCrWSi35-25-4, GX10NiCrNb32-20, GX50CrNiSi30-30, G-NiCr28W, G-NiCrCoW, GX45NiCrSiNb45-35, GX13NiCrNb45-35, GX13NiCrNb37-25, GX55NiCrWZr33-30-04.

62. The composite tube of claim 45, wherein the second tube member is made from a at least one material selected from the group consisting of same material as the first tube member, a ceramic material, an intermetallic material, and an ODS material.

63. A process, comprising the steps of:
contacting a powder with an inner or outer surface of a centrifugally cast first tube member;
compacting the powder by pressure treatment to form a second tube member; and
joining the second tube member to the first tube member to produce a composite tube.

64. The process of claim 63, further comprising the step of heating the powder.

65. The process of claim 63, further comprising the step of pre-compacting the powder prior to the pressure treatment.

66. The process of claim 65, wherein the pre-compacting step includes the step of shaking the powder.

67. The process of claim 63, wherein the contacting step includes the steps of inserting a core into a centrifugally cast tube, filling a clear space which remains between the inner surface of the centrifugally cast tube and the core with powder, placing the centrifugally cast tube under pressure while simultaneously heating the powder, and further comprising the step of removing the core from the composite tube after the pressure treatment step.

68. The process of claims 67, wherein the clear space is closed at at least one end of the tube.

69. The process of claim 67, wherein the core has a fin profile that is an inverse of a fin profile to be produced on an inside of the composite tube.

70. The process of claim 67, wherein the core is removed from the composite tube at least in part by means of etching.

71. The process of claim 63, wherein the contacting step includes the steps of inserting the centrifugally cast tube into a mould, filling a clear space which remains between the outer surface of the centrifugally cast tube and the mould with powder, placing the centrifugally cast tube under pressure while simultaneously heating the powder, and further comprising the step of removing the composite tube from the mould after the pressure treatment step.

72. The process of claim 70, wherein the clear space is closed at at least one end of the tube.

73. The process of claim 63, wherein a pressure of at least 450 bar is generated for the pressure treatment.

74. The process of claim 64, wherein the powder is heated to a temperature of at least 450° C.

75. The process of claim 64, wherein the powder is heated under an inert atmosphere.

76. The process of claim 63, wherein the pressure treatment is carried out in an inert atmosphere.

77. The process of claim 65, wherein a plurality of tubes are produced in a pressure chamber.

78. The process of claim 63, wherein the composite tube has axially parallel fins, further comprising the step of twisting ends of the composite tube with respect to one another.

79. The process of claim 63, further comprising the step of using the composite tube for thermal cracking of hydrocarbons in the presence of steam.

80. The process of claim 79, wherein the using step includes the steps of passing a charge mixture through externally heated composite tubes with helical internal fins to generate a swirling flow in an immediate vicinity of the fins, and transferring the swirling flow to a core zone with a predominantly axial flow at increasing radial distance from the fins.

81. The process of claim 80, wherein the swirling flow is able to sweep up turbulence separating at flanks of the internal fins.

82. The process of claim 80, further comprising the step of conducting a gas through the composite tubes having fin peaks and fin valleys, wherein a circumferential velocity of the gas flow in fin valleys of the internal fins is greater than at the fin peaks of the internal fins.

83. The process of claim 80, wherein the swirling flow at the fins runs at an angle of 20° to 40° with respect to a tube axis.

84. The process of claim 80, wherein the swirling flow at the fins runs at an angle of 22.5 to 32.5° with respect to a tube axis.

85. The process of claim 80, wherein a fluctuation in an inner-wall temperature across a circumference of the composite tube is less than 12° C.

86. The process of claim 80, wherein isotherms in the core zone are circular.

87. The process of claim 80, wherein the swirling flow has a velocity which increases by 1.8 to 2.0 m/s per meter of tube length.

88. The process of claim 80, wherein the swirling flow has a velocity which covers 7% to 8% of a clear cross section per meter of tube length.

89. The process of claim 80, wherein a temperature homogeneity factor over a cross section and a temperature homogeneity factor with respect to a hydraulic diameter is over 1 in relation to homogeneity factors of a smooth tube.

90. The process of claim 63, further comprising the step of using the composite tube for high-temperature applications.

91. The process of claim 89, wherein the composite tube is used in a rotary tubular kiln or a refuse incineration plant.

92. A composite tube for use in a tube furnace for thermal cracking of hydrocarbons in the presence of steam.
